(19) United States
(12) Patent Application Publication
(10) Pub. No.: US 2012/0137201 A1
(43) Pub. Date: May 31, 2012

(54) ENABLING PREDICTIVE WEB BROWSING

(75) Inventors: Christopher A. White, Neshanic Station, NJ (US); Christopher D. Jones, Basking Ridge, NJ (US)

(73) Assignee: Alcatel-Lucent USA Inc., Murray Hill, NJ (US)

(21) Appl. No.: 12/956,066

(22) Filed: Nov. 30, 2010

(51) Int. Cl. G06F 17/00

(52) U.S. Cl. 715/205

(57) ABSTRACT

A system and method for determining and displaying, in a predictive manner, relevant “next clicks” based upon historical web-usage patterns of previous visitors (the browsing user and/or other users) to referring web pages. In one embodiment, identification of one or more links selected by previous visitors on a plurality of referring web pages is stored in a database. When the browsing user initiates a request to view a referring web page for which one or more links exist in the database, the appearance of those links on the referring web page is altered to suggest those links to the browsing user. Thus, the browsing user is given suggestions as to the most probable path (based upon his/her own history and/or the history of others) through each referring web page for which one or more links are stored in the database, thereby streamlining the browsing process.

### BACKGROUND OF THE INVENTION

1. Field of the Invention

This invention relates generally to the field of computer networks, and, in particular, to web browsing.

2. Description of the Related Art

The World-Wide Web (the “web”) is a collection of web pages and other viewable files that are interconnected to one another over the network known as the Internet. A user typically browses web pages using a web browser program running on a client computing device, such as a laptop or desktop computer, mobile phone, or other wired or wireless device connected to the Internet. The address of the web page currently being viewed, known as the uniform resource locator (URL), is generally displayed within the user's web browser.

A given web page (known as a “referring” web page) can permit a user to navigate to one or more other web pages (known as “linked” web pages) by means of one or more links (also called “hyperlinks”) A link is an item on the referring web page that, when selected, transfers a user directly to view another location, either on the referring web page, or on a different linked web page. Accordingly, a link specifies at least the location (e.g., URL) of the linked web page. A link can also specify the name or title of the linked web page, and some links also specify a specific location within the linked web page. It should be understood that the word “link” is used in the art to refer both to the location (e.g., URL) of the linked web page and to the selectable item (e.g., an underlined group of words, an icon, or a picture) on the referring web page on which the user clicks to navigate to the linked web page.

Links to linked web pages are typically graphically denoted within the referring web page via underlining or bold text, and sometimes by a graphic item (e.g., an icon or a picture) that the user selects. By selecting a link (typically by mouse click), the user directs the browser to load, acquire, and display the corresponding linked web page to which the link points.

Using a web browser typically entails a combination of two different methods, both web browsing and web searching.

The process of web browsing involves the user moving from web page to web page by selecting links on currently-displayed web pages, completely at the whim of the user. This process is often performed with the user having little or no information as to the relevance of a given linked web page to the user's particular topic of interest. Moreover, the user often cannot discern whether a linked web page is relevant until the user actually clicks on the link and subsequently views the linked web page. One reason this happens is that many links are short or contain little description about the linked web pages to which they refer. For example, some links might simply state “Click Here” or “More.” Thus, it is not always possible during the process of web browsing for the user to obtain a sense of the relevance of a linked web page to which a given link points, and it can therefore be difficult for a user to select manually, by way of browsing, pages that are actually relevant.

In contrast to the relatively undirected process of web browsing, the process of web searching generally involves the user employing a search engine, e.g., Google (http://www.google.com) or Yahoo (http://www.yahoo.com), to find information available about a given topic of interest. When web searching, the user inputs, into a search engine, relevant keywords about the topic, and the search engine then returns a list of links to linked web sites that may relate to the topic.

Although search engines provide the most prevalent method for users to obtain relevant information on the web today, as the volume of web pages on the web continuously increases, the relevance of search results tends to decrease. Significant research is being conducted in an attempt to address this difficulty, including improving web page-rank evaluations, methods of refining searches, and methods of categorizing information based on input from other users. All of these methods require an active query from the browsing user to determine relevant sites. Further, these search engine-based solutions provide only the selection of a single entry point into a web site. In other words, the user enters search keywords and receives a list of links to potentially-relevant web pages returned as search results. However, once the user clicks on one of the links in the list and is taken to the corresponding linked web page, the user is left without any guidance as to which link on the linked web page and subsequent linked web pages the user should select, and the user is forced to return to the undirected process of web browsing to navigate further within the linked web pages returned as search results.

### SUMMARY OF THE INVENTION

Problems in the prior art are addressed in accordance with the principles of the present invention by providing a system and method for determining and displaying, in a predictive manner, relevant “next clicks” based upon historical web-usage patterns of the browsing user and/or other users. In certain embodiments of the invention, identification of one or more links selected by previous visitors on a plurality of referring web pages is stored in a database. When the browsing user initiates a request to view a referring web page for which one or more links exist in the database, the appearance of those links on the referring web page is altered to suggest those links to the browsing user. Thus, the browsing user is given suggestions as to the most probable path (based upon their own history and/or the history of others) through each referring web page for which one or more links are stored in the database, thereby streamlining the browsing process.

In one embodiment, the invention provides a computer-implemented method for displaying web pages to a current user of a web browser running on a computing device. The method includes: (a) storing identification of (i) one or more referring web pages visited by one or more previous visitors and, (ii) for each of the one or more referring web pages, one or more links on the referring web page selected by the one or more previous visitors who visited the referring web page; and (b) in response to the initiation by the current user of a request to view one of the one or more referring web pages, and based on the stored identification of the one or more links on the requested referring web page selected by the one or more previous visitors who visited the referring web page, altering the appearance of the requested referring web page displayed to the current user.

In another embodiment, the invention provides an apparatus for displaying web pages to a current user of a web browser running on a computing device. The apparatus includes a database and a processor. The database is adapted to store identification of (i) one or more referring web pages visited by one or more previous visitors and, (ii) for each of the one or more referring web pages, one or more links on the referring web page selected by the one or more previous visitors who visited the referring web page. The processor is adapted, in response to the initiation by the current user of a request to view one of the one or more referring web pages, and based on the stored identification of the one or more links on the requested referring web page selected by the one or more previous visitors who visited the referring web page, to alter the appearance of the requested referring web page displayed to the current user.

In a further embodiment, the invention provides a non-transitory machine-readable storage medium, having encoded thereon program code, wherein, when the program code is executed by a machine, the machine implements a method for displaying web pages to a current user of a web browser running on a computing device. The method includes: (a) storing identification of (i) one or more referring web pages visited by one or more previous visitors and, (ii) for each of the one or more referring web pages, one or more links on the referring web page selected by the one or more previous visitors who visited the referring web page; and (b) in response to the initiation by the current user of a request to view one of the one or more referring web pages, and based on the stored identification of the one or more links on the requested referring web page selected by the one or more previous visitors who visited the referring web page, altering the appearance of the requested referring web page displayed to the current user.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a block diagram depicting an exemplary predictive web-browsing system in accordance with a first embodiment of the invention;

FIG. 2 is a block diagram depicting an exemplary predictive web-browsing system in accordance with a second embodiment of the invention; and

FIG. 3 is a flow diagram depicting an exemplary method of predictive web browsing in accordance with certain embodiments of the invention.

### DETAILED DESCRIPTION

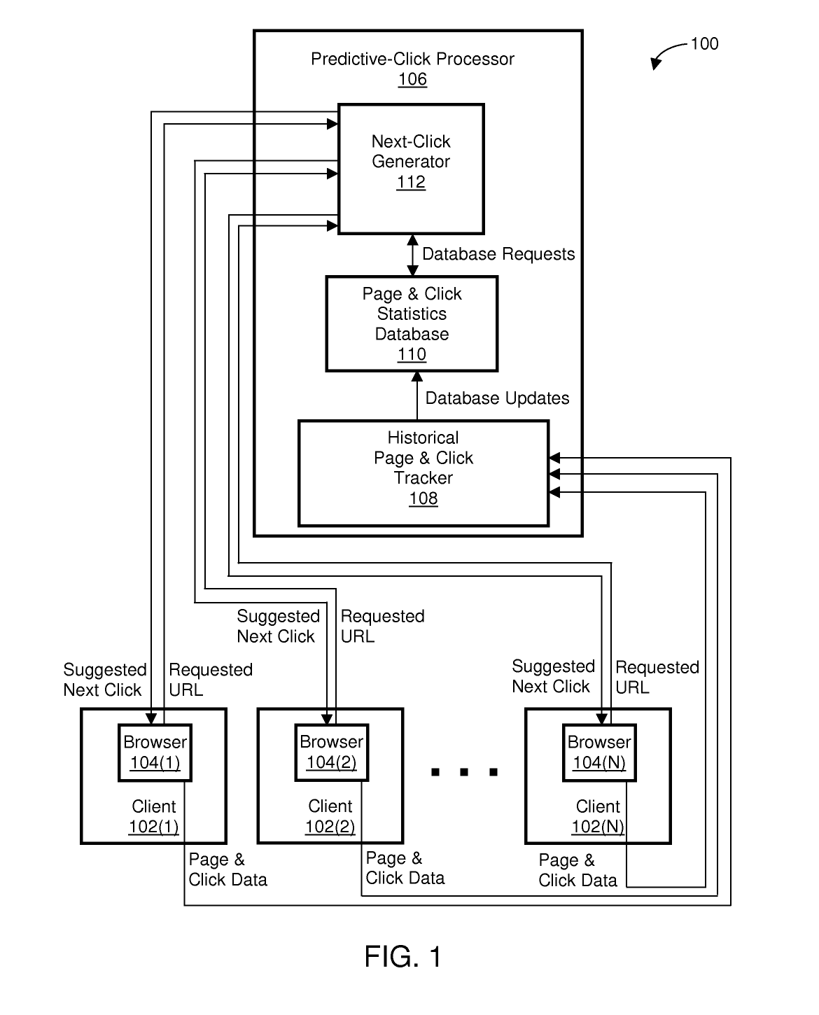

FIG. 1 depicts an exemplary predictive web-browsing system 100, consistent with a first embodiment of the invention. System 100 includes one or more clients 102(1), 102(2), . . . , 102(N) in communication with a predictive-click processor 106 via the Internet (not shown). Each client 102(i) is a computing device on which a respective web browser 104(i) runs. Although, in the discussion below, the operations of only client 102(1) and browser 104(1) are described, it should be understood that, in embodiments with multiple clients, the operations of clients 102(2) through 102(N) and browsers 104(2) through 104(N) are substantially the same as those described below for client 102(1) and browser 104(1), respectively.

Predictive-click processor 106 includes a historical page and click tracker 108, a page and click statistics database 110, and a next-click generator 112.

A user operates browser 104(1) on client 102(1) to browse the web. During the browsing process, browser 104(1), pursuant to the HyperText Transfer Protocol (HTTP), requests pages from web servers (not shown) by sending packets of text called HTTP requests, and those web servers reply by sending the requested pages, preceded by packets of text called HTTP responses. It is noted that, for clarity, the HTTP requests sent to web servers by browser 104(1) and the HTTP responses and web pages received from web servers by browser 104(1), all of which are exchanged during normal operation of browser 104(1), are omitted from FIG. 1.

In this embodiment, browser 104(1) provides, to historical page and click tracker 108 of predictive-click processor 106, information about which link(s) on each referring page the user has clicked (i.e., selected) during browsing. Specifically, for each link clicked by the user, browser 104(1) provides to historical page and click tracker 108 both (i) page data, i.e., the URL identifying the referring web page containing the link that was clicked and (ii) click data, i.e., identification of which link on the referring web page was clicked.

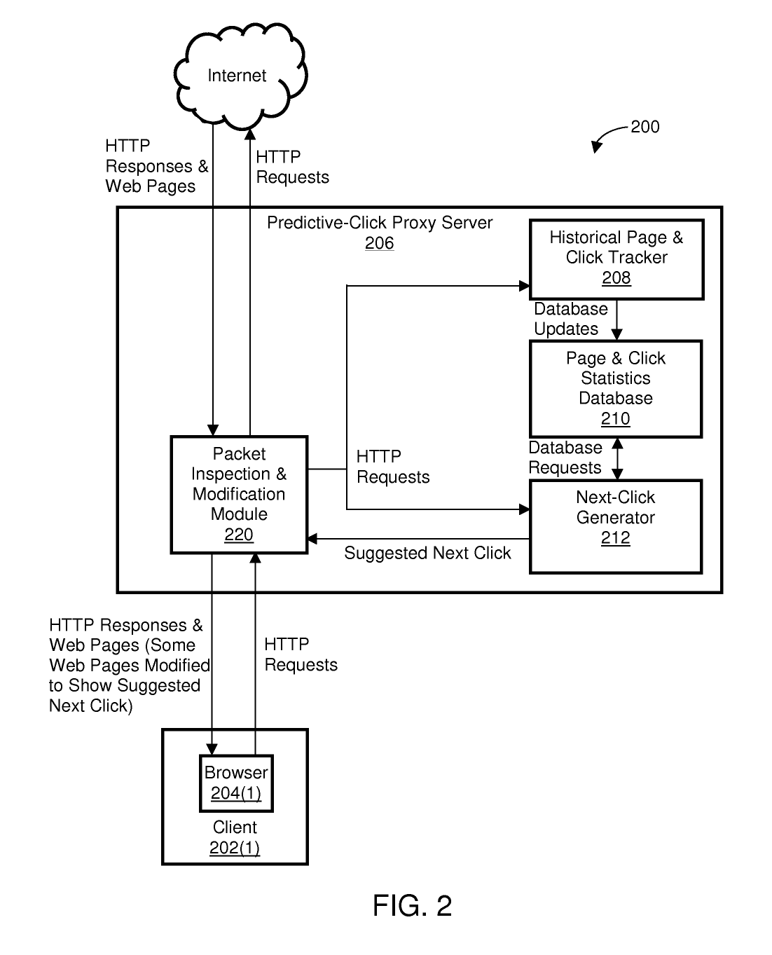

In various embodiments of the invention, the transmission of page data and click data from browser 104(1) to historical page and click tracker 108 can be accomplished by several different methods, including, e.g., the use of a customized browser having this capability or a plug-in or add-on software module for an existing browser to provide this capability. (In alternative embodiments, as will be discussed in further detail with respect to FIG. 2, an ordinary, unmodified browser can be used for browsing, in which case, packet inspection is used to extract page data and click data from the browser's outgoing traffic stream.)

Although, in the embodiment of FIG. 1, browser 104(1) provides page data and click data in real time while the user browses the web, it is contemplated that, to reduce network congestion and processing overhead, in other embodiments, page data and click data could be provided to historical page and click tracker 108 either at periodic intervals (e.g., once per hour or per day), or alternatively, during periods when browser 104(1) and/or client 102(1) are determined to be idle or when sufficient unused network bandwidth is detected.

Page and click statistics database 110 contains one or more data structures for storing (i) a plurality of URLs identifying a plurality of referring web pages containing links that were clicked by one or more users and, (ii) for each URL in the database, data identifying the frequency with which one or more links on the corresponding referring web page were previously clicked by the one or more users. Historical page and click tracker 108 receives and aggregates the page data and click data from browser 104(1) and uses that data to update page and click statistics database 110. In this embodiment, database 110 is updated using an algorithm implemented in historical page and click tracker 108 that tracks and stores in database 110 data identifying the number of times a plurality of links on each referring web page were previously clicked by the one or more users. From this information, the most frequently clicked link can be determined, which will typically be the link that a user is most likely to select when viewing that referring web page. Therefore, it is desirable to suggest this link to one or more subsequent users who land on that referring web page, as will now be described.

During a normal operation of browser 104(1) on client 102(1) to browse the web, the user will view a series of referring web pages provided by various web servers. In addition to browser 104(1) transmitting to historical page and click tracker 108 information about the referring web pages being viewed, browser 104(1) also transmits to next-click generator 112, in real time, the URL of every referring web page being viewed. Next-click generator 112 uses this URL to perform a query on page and click statistics database 110. If there is an entry for the URL in database 110, then next-click generator 112 receives, as a result of the query, the most frequently clicked link for the referring web page identified by that URL. (If more than a single link on a referring web page has previously been selected with the same highest frequency, then the “tie” is broken by randomly selecting any one of those highest-frequency links.) If there is no entry for the URL in page and click statistics database 110, then next-click generator 112 receives, as a result of the query, an error flag.

Next-click generator 112 then provides to browser 104(1) either a suggested “next click,” which is the most frequently clicked link on the referring web page identified by the URL, or else an error flag indicating that a most frequently clicked link does not exist for the URL. If browser 104(1) receives an error flag, then no action is taken by browser 104(1). However, if browser 104(1) receives a suggested next click, then browser 104(1) indicates that suggested next click to the user by altering the manner in which the corresponding link on the referring web page is displayed within the browser, such as by changing that link's color or size or otherwise modifying the appearance of that link Such alteration can be made either by modifying the underlying code (e.g., HTML code) of the referring web page or by manipulating the appearance of the link on the screen only, without modifying the underlying web page code.

The result of the foregoing operations is that the browsing user is given suggestions as to the most probable path (based upon their own history and/or the history of others) through each referring web page that has a corresponding most frequently clicked link stored in the database, thereby streamlining the browsing process by reducing the number of decisions that the user makes while browsing, or, at a minimum, assisting the user in making decisions while browsing. Each click by the browsing user will update the database based upon that user's browsing history to improve the suggested links subsequently provided to the user. Moreover, in embodiments in which data from multiple users is aggregated, a user can essentially access the collective knowledge of others, e.g., by being able to determine rapidly which links are the most useful when encountering a new web page or web site.

FIG. 2 depicts an exemplary predictive web-browsing system 100, consistent with a second embodiment of the invention. System 200 is similar to system 100 of FIG. 1, with the exception that, in this embodiment, the predictive-click processor functionality is integrated into a proxy server that also handles incoming and outgoing HTTP web traffic for one or more web browsers, as will be described in further detail below.

System 200 includes one or more clients 202(1), 202(2), . . . , 202(N) coupled to the Internet via a predictive-click proxy server 206, although, for clarity, only a single client 202(1) and browser 204(1) are shown in FIG. 2. Each client 202(i) is a computing device on which a respective web browser 204(i) runs. Although, in the discussion below, only the operations of client 202(1) and browser 204(1) are described, it should be understood that, in embodiments with multiple clients, the operations of clients 202(2) through 202(N) and browsers 204(2) through 204(N) are substantially the same as those described below for client 202(1) and browser 204(1).

Predictive-click proxy server 206 includes a historical page and click tracker 208, a page and click statistics database 210, a next-click generator 212, and a packet inspection and modification module 220. The operation of historical page and click tracker 208, page and click statistics database 210, and next-click generator 212 are substantially the same as that of historical page and click tracker 108, page and click statistics database 110, and next-click generator 112 of FIG. 1, respectively, except as otherwise described below.

In the embodiment of FIG. 2, browser 204(1) is an ordinary, unmodified browser, which the user configures to use predictive-click proxy server 206 as a proxy server for browsing by entering the IP address of predictive-click proxy server 206 into either a setting within browser 204(1) or an operating-system setting on client 202(1). Once this setting has been configured, all HTTP requests and responses between browser 204(1) and the Internet will pass through predictive-click proxy server 206, which is configured to inspect packets containing HTTP requests and modify certain packets containing HTTP responses.

A user operates browser 204(1) on client 202(1) to browse the web. During the browsing process, browser 204(1) requests pages from web servers (not shown) by sending HTTP requests. Browser 204(1) provides the HTTP requests to predictive-click proxy server 206, where packet inspection and modification module 220 receives and forwards those HTTP requests to historical page and click tracker 208 and next-click generator 212. Packet inspection and modification module 220 also forwards those HTTP requests to the appropriate web servers on the Internet. Those web servers reply by sending the requested pages, preceded by HTTP responses, to predictive-click proxy server 206, where the web pages and HTTP responses are received by packet inspection and modification module 220. As will be described in further detail below, packet inspection and modification module 220 forwards to browser 204(1), without modification, referring web pages for which no most frequently clicked link exists. However, if a most frequently clicked link exists for a referring web page, then packet inspection and modification module 220 modifies that referring web page prior to forwarding it to browser 204(1).

Historical page and click tracker 208 receives the HTTP requests from packet inspection and modification module 220 and extracts information about which link on each referring web page the user has clicked (i.e., selected) during browsing. Specifically, historical page and click tracker 208 extracts, in real time, both (i) page data, i.e., the URL identifying the referring web page containing the link that was clicked and (ii) click data, i.e., identification of which link on the referring web page was clicked. Historical page and click tracker 208 uses the page data and click data from browser 204(1) data to update page and click statistics database 210.

Next-click generator 212 receives the HTTP requests and extracts page data from those HTTP requests to determine the URL identifying the referring web page containing the link that was clicked. Once the URL has been determined, next-click generator 212 uses this URL to perform a query on page and click statistics database 210. If there is an entry for the URL in database 210, then next-click generator 212 receives, as a result of the query, the most frequently clicked link for the referring web page identified by that URL. If there is no entry for the URL in page and click statistics database 210, then next-click generator 212 receives, as a result of the query, an error flag. Next-click generator 212 then provides to browser packet inspection and modification module 220 either a suggested next click, i.e., the most frequently clicked link on the referring web page identified by the URL, or else an error flag indicating that a most frequently clicked link does not exist for the URL.

If packet inspection and modification module 220 receives an error flag for a given referring web page, then no action is taken by packet inspection and modification module 220, and that referring web page is forwarded to browser 204(1) intact, i.e., without modification of the referring web page. However, if packet inspection and modification module 220 receives a suggested next click, then packet inspection and modification module 220 modifies the underlying code (e.g., HTML code) of the referring web page identified by the URL prior to forwarding that referring web page to browser 204(1), so that the suggested next click is indicated to the browsing user. Specifically, this modification of the referring web page's code is performed so that the referring web page visually suggests the most frequently clicked link to the user by altering the manner in which that link is displayed within the browser, such as by changing that link's color or size or otherwise modifying the appearance of that link (e.g., by adding HTML “bold” tags <b> and </b> around the link)

While the foregoing embodiment of FIG. 2 permits the use of an ordinary, unmodified browser, it is contemplated that, in certain embodiments, instead of altering the HTML code of referring web pages so that the alteration of the code itself changes the manner in which the most frequently clicked link is displayed, the HTML code could be altered to add a hidden field or flag (e.g., by adding an HTML “hidden” tag in the form of: <input type=“hidden”/>) that a custom browser (or browser plug-in or add-on) detects to initiate manipulation by the browser of the appearance of the link on the screen only.

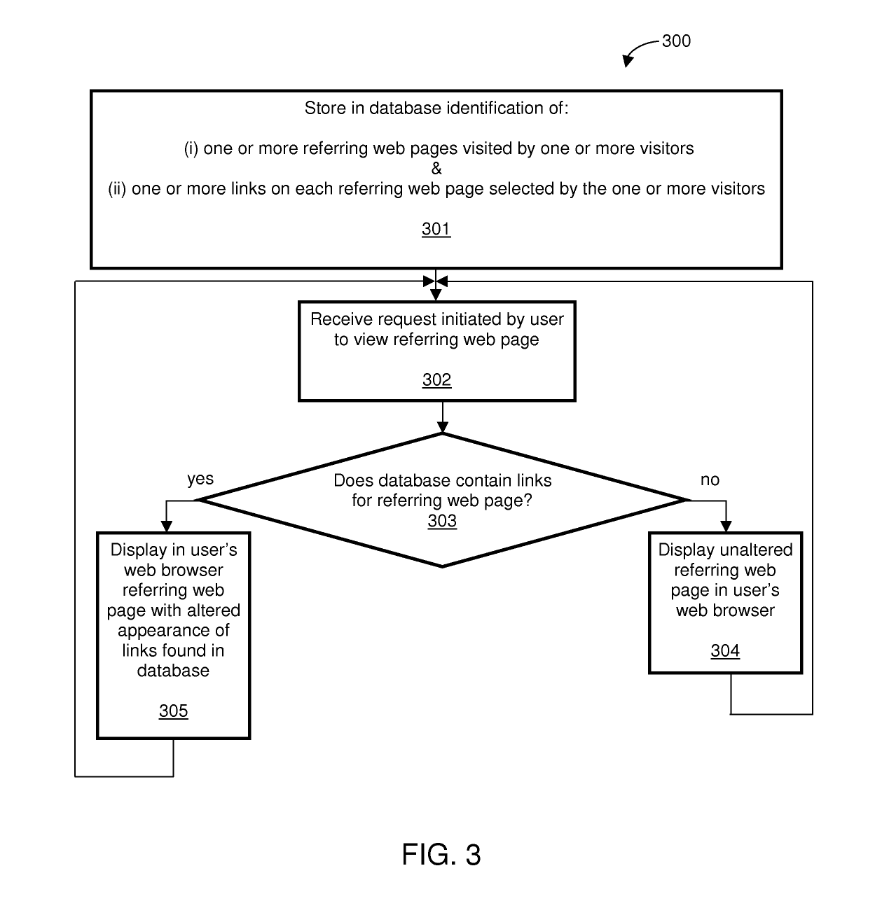

FIG. 3 is a flow diagram illustrating an exemplary method 300 for displaying web pages to a current user of a web browser running on a computing device. First, at step 301, identification of (i) one or more referring web pages visited by one or more visitors and, (ii) for each of the one or more referring web pages, data identifying the frequency with which one or more links on the referring web page were previously selected by the one or more visitors who visited the referring web page, is stored in a database. Next, at step 302, a request initiated by the current user to view one of the referring web pages is received. Next, at step 303, a determination is made whether the database contains one or more links on the referring web page that were identified as having been selected by the one or more previous visitors who visited the referring web page. If, at step 303, it is determined that the database does not contain any such links for the referring web page, then, at step 304, an unaltered version of the referring web page is displayed in the user's web browser. If, at step 303, it is determined that the database contains one or more such links, then, at step 305, an altered version of the referring web page, in which the appearance of those links contained in the database is altered, is displayed in the user's web browser. Following either step 304 or 305, the method returns to step 302 to receive another request from the current user to view another referring web page.

In alternative embodiments of the invention, in addition to, or instead of, the browser altering the appearance of the most frequently clicked link, the browser could be configured to move the cursor or mouse pointer automatically to “hover” over the most frequently clicked link after loading a referring web page, so that the user merely clicks the mouse or presses a predetermined keystroke to navigate to that link.

In other alternative embodiments of the invention, the most frequently clicked link could be indicated in other ways, such as by displaying the link itself in a specified location (such as at the top or bottom of the screen, or in a separate window), or by displaying the actual linked web page corresponding to that link in a specified location (such as at the top or bottom of the screen, or in a separate window).

In further alternative embodiments, even if the most frequently clicked link is not actually displayed on-screen, the browser could be configured so that a predefined keystroke, mouse gesture, click of an on-screen button in a predetermined location, or similar action by the user automatically causes the browser to navigate to the most frequently clicked link on the currently-displayed referring web page, regardless of the then-current location of the mouse cursor or pointer.

Moreover, although the foregoing described embodiments involve the page and click statistics database returning only a single most frequently clicked link corresponding to each

URL, it should be recognized that additional information could be retrieved from the database in other embodiments of the invention. For example, identification of two or more selectable links corresponding to each URL, coupled with statistical information comprising, e.g., (i) the number of “clicks” by the one or more users for each of those links and/or (ii) the frequency with which each of those links was selected by the one or more users, could be maintained in and retrieved from the database and presented to the user. In this scenario, the database could provide such statistical information reflecting the popularity of one or more links appearing on a given referring web page to the next-click generator as part of the query results. The browser would receive this statistical information (either in the form of a “click” count or a percentage) from the next-click generator and would be configured (either instead of or in addition to displaying or otherwise indicating the single most frequently clicked link) to indicate to the browsing user the percentage of time each of the selectable links was selected by the one or more users who visited a given referring web page. The popularity for a given link could be displayed as a number (indicating either “click” count or percentage), such as a number appearing in a “tool tip” when the user hovers over a link, or indicated using other means, such as by color-coding the most frequently clicked links with a predetermined color scheme (e.g., green for the most frequently-clicked links, yellow for less frequently-clicked links, and red for infrequently-clicked links), so that the user can easily discern, at a glance, the ranking of links most frequently selected by the one or more users. If the number displayed for a link represents frequency (e.g., percentage of time the link was previously selected), then that number inherently reflects not only the popularity of that link based on historical data, but also the probability that the current browsing user will select that link This arrangement provides users with the ability, by simply “mousing” over a link on a referring web page, to determine the percentage (or number) of people who have selected that link in the past.

It should also be recognized that certain embodiments of the invention involve suggesting next clicks to a user based only on that single user's browsing history (or, e.g., the browsing history of all users who share a particular IP address), while other embodiments involve aggregating browsing histories for a plurality of users at different client computers to determine which next click should be suggested to a user. The plurality of users from which browsing histories are aggregated could be all browsing users on the Internet, or select groups of users based on, e.g., a social network consisting of the user's personally-chosen friends, a geographic location (e.g., users in the same neighborhood, state, or country), one or more common interests shared by a group of users (e.g., chess enthusiasts or users sharing a particular religion), a particular age group, or the like. In some embodiments, the links selected by the browsing user himself/herself are weighted more heavily so as to have greater influence over the aggregated link-selection information than links selected by other users.

When aggregating browsing history data from users, some embodiments of the invention might count multiple instances of selection of the same link by a single user as multiple selections, while other embodiments might count multiple instances of selection of the same link by a single user as only a single selection.

Additionally, different embodiments of the invention involve suggesting next clicks based on the aggregation of browsing histories from different time frames. For example, browsing histories from only the past week or the past month might be used to suggest next clicks. The time windows from which data is used to suggest links can also be adjusted to emphasize past browsing history (e.g., using historical data aggregated over a long period of time), to emphasize current browsing history (e.g., for the current session, for the current week, for the last N clicks by that user), or various combinations of past and current browsing history. In some embodiments, different time periods are weighted differently. For example, more recently selected links could be weighted more heavily so as to have greater influence over the aggregated link-selection information than links selected during less recent time periods.

In different embodiments of the invention, different types of information might be stored to indicate historical link selections by users. For example, the page and click statistics database might contain entire specific URLS to indicate links chosen (e.g., http://host.domain.com/page.htm), or might contain merely a domain name (e.g., host.domain.com) or portion of a domain name (e.g., domain.com) corresponding to a selected URL, to indicate a most relevant link or set of links In the latter scenario, the appearance of all links to that domain name (or portion thereof) on a referring web page viewed by the browsing user could be manipulated to suggest a plurality of links to the user.

Although embodiments of the invention are described above as being implemented in a predictive-click processor or a predictive-click proxy server, it is contemplated that the invention could also be embodied in a router owned by an Internet service provider (ISP) or in a single personal computer client containing a browser.

Additionally, the information in page and click statistics database could alternatively be stored in other locations and could be obtained by other methods, such as bulk transfer from external entities, such as data warehouses, that aggregate historical information regarding links selected by one or more users during browsing.

It is further contemplated that, in certain embodiments of the present invention that employ custom software (e.g., a plug-in or add-on software module) to modify a browser, such custom software could provide additional functionality. For example, the user could have selectable options to shape the set of historical data used to suggest links, or to add contextual information to improve the suggestion of links, such as permitting the user to provide feedback regarding the quality of links that are suggested. If a user indicates (e.g., using a predetermined keystroke or mouse gesture) that a suggested link on a referring web page is not relevant to that user, then such feedback could be used, e.g., to prevent that link (or other links with the same domain name) from being suggested to the user in the future when arriving at that referring web page, or even when arriving at any other referring web pages on which that link appears (or on which other links with the same domain name appear).

Further, although the data representing information about links selected by users does not necessarily need to be stored in a standardized format, standardization could be used to enhance the ability to share browsing history data across multiple users and multiple types of software and platforms.

Methods consistent with embodiments of the invention could alternatively be implemented in a web site, without the use of a proxy server or any browser customization (such as a plug-in or add-on software module). In this scenario, the web site would track the links selected by one or more visitors to various referring pages within the web site and would provide suggested next clicks to one or more current users of the web site by visually altering the way certain links on referring pages within the web site appear to those current users (e.g., as described above with respect to FIG. 1). A similar implementation could be used for a set of web sites, a domain, or a set of domains. Links on referring pages could be suggested to a user either (i) based on links selected by the same user during the user's previous visits to those referring pages, (ii) based on links selected by other visitors to those referring pages, or (iii) a combination of links selected by the same user and by other visitors.

In certain embodiments of the invention, next clicks are suggested based on statistics characterizing the frequency with which links are selected, as described above. However, in other embodiments of the invention, a user's past or recent browsing history could be used to determine suggested next clicks based on Bayesian inference, i.e., an approach that makes statistical inferences in cases where some of the probabilities are interpreted as representing beliefs, or knowledge, rather than a purely frequency-based interpretation. In other words, based on the links a user clicks, that user's behavior can be learned and better predicted, so that future suggested next clicks are tailored to that particular user. Such behavior can be stored in the form of a user profile, and the stored profile information can be used either alone or in conjunction with page data and click data to improve the suggestions of next clicks. The profiles could be user-specific or could characterize certain categories of users.

In the case of profiles that characterize certain categories of users, such profiles are used to bias suggestions toward content more relevant for the browsing user and away from content less relevant to the browsing user. For example, certain content-based user-selectable profiles would be provided so that, e.g., a user who is a new parent of a child but has no pets could select a profile for new parents and deselect a profile for pet owners, resulting in improved next-click suggestions. In the foregoing example, suggestions are biased toward new parent-related links and away from pet-related links, such that the user is presented with suggestions for links that a typical new parent would select, but is not presented with suggestions for links that a pet owner would select, even if a pet-related link is otherwise that “best” next click. By observing the browsing patterns of the user and/or the browsing patterns of other users who share certain characteristics, improved next-click results can be provided.

In alternative embodiments, instead of next clicks being individually chosen on the basis of the frequency with which a single link is selected, joint probabilities are used to suggest next clicks. In such embodiments, for each web page, the page and click statistics database stores one or more paths consisting of sequences of links that are frequently selected. For example, once a user clicks link A₁ on a first web page, that user is likely to select link B₁ on the next web page, followed by selecting link C₁ on the next web page, and so forth.

Another example involves a web site having four pages (A, B, C, and D), with each page containing four links that have equal probabilities of being selected (i.e., page A has links A₁, A₂, A₃, A₄, each of which is selected 25% of the time by all users landing on page A; page B has links B₁, B₂, B₃, B₄, each of which is selected 25% of the time by all users landing on page B; and so forth). Without the use of additional information, it would be difficult to suggest any one of links B₁, B₂, B₃, B₄ to a user who lands on page B by clicking link A₁ on page A, because of the equal probabilities of selection for links B₁, B₂, B₃, and B₄. This additional information can be obtained using stored sequences of next clicks in the page and click statistics database. An example of a stored sequence of next clicks for this exemplary four-page web site might be A₁→B₃→C₁, which represents the fact that users who selected link A₁ on page A also selected link B₃ on page B most (e.g., 100%) of the time, and then further selected link C₁ most (e.g., 80%) of the time. Based on this stored information, it can be inferred that a user who has just selected link A₁ on page A will most likely select link B₃ on page B (even though only 25% of all users landing on page B from all referring pages selected link B₃) and will then most likely select link C₁ on page C (even though only 25% of all users landing on page C from all referring pages selected link C₁). In this manner, the selection of link A₁ on page A, link B₃ on page B, and link C₁ on page C are correlated based on the stored sequence of next clicks. Thus, in the above-described scenario of a user landing on page B, on which four links (B₁, B₂, B₃, B₄) would normally have equal probabilities of being selected, next-click generator would suggest link B₃ as the best choice (based on stored sequences of next clicks in the page and click statistics database), given the fact that the user landed on page B by clicking on link A₁. Although storing a large number of sequences of next clicks in the page and click statistics database could be impractical, storage space can be reduced by storing only a portion of the sequence of links selected by one or more users, e.g., by storing only the most recent 4 or 5 links in a sequence of links selected by a given user. By storing sequences of links in the foregoing manner, pathways through various web pages can be suggested to a user based on pathways previously selected by that user or other users, instead of each link suggestion being made independently based on the current page being viewed by the user.

Embodiments of the present invention present a different way for a user to find relevant information on the Internet, different from the experience provided by search engines. This is done by providing browsing methods that indicate to the browsing user, on a link-by-link basis, which links through a series of referring web pages are most likely to lead to the most relevant path or most popular path. While search engines provide a list of only one navigable specific link at a time, such as a relevant link buried deep within a complex web site, search engines provide little or no indication of the path through referring pages used to arrive at that navigable specific link The process of link-by-link browsing and suggestion consistent with embodiments of the invention, which provides the user with information about paths used to arrive at various links, would be difficult, if not impossible, for a search engine to provide.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The present invention can also be embodied in the form of a bitstream or other sequence of signal values stored in a non-transitory recording medium generated using a method and/or an apparatus of the present invention.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims are recited in a particular sequence with corresponding labeling, unless the claim recitations otherwise imply a particular sequence for implementing some or all of those elements, those elements are not necessarily intended to be limited to being implemented in that particular sequence.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

We claim:

1. A computer-implemented method for displaying web pages to a current user of a web browser running on a computing device, the method comprising:
(a) storing identification of (i) one or more referring web pages visited by one or more previous visitors and, (ii) for each of the one or more referring web pages, one or more links on the referring web page selected by the one or more previous visitors who visited the referring web page;
(b) in response to the initiation by the current user of a request to view one of the one or more referring web pages, and based on the stored identification of the one or more links on the requested referring web page selected by the one or more previous visitors who visited the referring web page, altering the appearance of the requested referring web page displayed to the current user.

2. The invention of claim 1, wherein the one or more previous visitors includes the current user.

3. The invention of claim 2, wherein the one or more previous visitors consists of only the current user.

4. The invention of claim 1, wherein step (b) comprises:
(b1) altering the appearance of at least one of the one or more links on the referring web page selected by the one or more previous visitors who visited the referring web page.

5. The invention of claim 4, wherein step (b1) comprises altering the underlying code of the referring web page.

6. The invention of claim 4, wherein step (b1) comprises manipulating, in the web browser display, the appearance of the at least one of the one or more links on the referring web page, without altering the underlying code of the referring web page.

7. The invention of claim 1, wherein step (b) comprises:
(b1) moving a cursor or pointer to at least one of the one or more links on the referring web page selected by the one or more previous visitors who visited the referring web page.

8. The invention of claim 1, further comprising:
(c) displaying, in a predetermined location in the web browser display, at least one of:
(i) at least one of the one or more links on the referring web page selected by the one or more previous visitors who visited the referring web page, and
(ii) at least one linked web page corresponding to at least one of the one or more links on the referring web page selected by the one or more previous visitors who visited the referring web page.

9. The invention of claim 1, wherein:
step (a) comprises storing at least one sequence of links comprising two or more links sequentially selected by the one or more previous visitors who visited the referring web page, and
the method comprises performing step (b) two or more times for two or more respective links in the at least one sequence of links

10. The invention of claim 1, further comprising:
(c) storing, for each of the one or more links on the referring web page selected by the one or more previous visitors who visited the referring web page, statistical information reflecting the number of times the one or more users selected each of the one or more links; and
(d) in response to the initiation by the current user of the request to view the one of the one or more referring web pages, and based on the statistical information, altering the appearance of the requested referring web page displayed to the current user.

11. The invention of claim 10, wherein step (d) comprises displaying the statistical information for the one or more links corresponding to the one of the one or more referring web pages.

12. The invention of claim 10, wherein step (d) comprises displaying one or more colors for the one or more links corresponding to the one of the one or more referring web pages, wherein the one or more colors are selected based on the statistical information.

13. The invention of claim 1, further comprising receiving at a proxy server, prior to step (a), the identification of (i) the one or more referring web pages visited by the one or more previous visitors and, (ii) for each of the one or more referring web pages, the one or more links on the referring web page selected by the one or more previous visitors who visited the referring web page.

14. Apparatus for displaying web pages to a current user of a web browser running on a computing device, the apparatus comprising:
a database adapted to store identification of (i) one or more referring web pages visited by one or more previous visitors and, (ii) for each of the one or more referring web pages, one or more links on the referring web page selected by the one or more previous visitors who visited the referring web page; and
a processor adapted, in response to the initiation by the current user of a request to view one of the one or more referring web pages, and based on the stored identification of the one or more links on the requested referring web page selected by the one or more previous visitors who visited the referring web page, to alter the appearance of the requested referring web page displayed to the current user.

15. The invention of claim 14, wherein the processor is adapted to alter the appearance of at least one of the one or more links on the referring web page selected by the one or more previous visitors who visited the referring web page.

16. The invention of claim 15, wherein the alteration of the appearance of the at least one of the one or more links on the referring web page comprises altering the underlying code of the referring web page.

17. The invention of claim 14, wherein the processor is adapted to move a cursor or pointer to at least one of the one or more links on the referring web page selected by the one or more previous visitors who visited the referring web page.

18. The invention of claim 14, wherein the processor is adapted to:
store, for each of the one or more links on the referring web page selected by the one or more previous visitors who visited the referring web page, statistical information reflecting the number of times the one or more users selected each of the one or more links; and
in response to the initiation by the current user of the request to view the one of the one or more referring web pages, and based on the statistical information, alter the appearance of the requested referring web page displayed to the current user.

19. The invention of claim 14, further comprising a proxy server adapted to receive the identification of (i) the one or more referring web pages visited by the one or more previous visitors and, (ii) for each of the one or more referring web pages, the one or more links on the referring web page selected by the one or more previous visitors who visited the referring web page.

20. A non-transitory machine-readable storage medium, having encoded thereon program code, wherein, when the program code is executed by a machine, the machine implements a method for displaying web pages to a current user of a web browser running on a computing device, the method comprising:
(a) storing identification of (i) one or more referring web pages visited by one or more previous visitors and, (ii) for each of the one or more referring web pages, one or more links on the referring web page selected by the one or more previous visitors who visited the referring web page;
(b) in response to the initiation by the current user of a request to view one of the one or more referring web pages, and based on the stored identification of the one or more links on the requested referring web page selected by the one or more previous visitors who visited the referring web page, altering the appearance of the requested referring web page displayed to the current user.
